(19) United States
(12) Patent Application Publication
(10) Pub. No.: US 2013/0217464 A1
(43) Pub. Date: Aug. 22, 2013

(54) ELECTRONIC GAME MACHINE WITH MULTIPLIER BASED REWARDS

(71) Applicant: Incredible Technologies, Inc., (US)

(72) Inventor: James M. Terdina, Bartlett, IL (US)

(73) Assignee: Incredible Technologies, Inc., Vernon Hills, IL (US)

(21) Appl. No.: 13/746,949

(22) Filed: Jan. 22, 2013

Related U.S. Application Data
(60) Provisional application No. 61/600,057, filed on Feb. 17, 2012.

(51) Int. Cl. G07F 17/32

(52) U.S. Cl. CPC G07F 17/3288; G07F 17/3211
USPC 463/20

(57) ABSTRACT

An electronic gaming machine and method providing for multiplier-based rewards where the outcome of a random configuration of game elements produces a predetermined winning outcome. The gaming machine features a game display presenting an array having a plurality of game elements. During play of the game, the game elements are randomly variable to form a configuration on the array. The configuration can be either a predetermined winning or non-winning outcome of the game, with a winning outcome characterized by adjacent game elements having at least one identical property. Where a winning outcome has been produced, the game can present a winning indicator symbol where features of the winning game elements interact with one another. Where a player has wagered on the outcome of the game, the game can further provide for a multiplier that scales the wager by a predetermined factor where a winning outcome is produced.

### CROSS REFERENCE TO RELATED APPLICATION

This application claims the benefit of U.S. Provisional Patent Application Ser. No. 61/600,057 filed Feb. 17, 2012, the entirety of which is incorporated herein by reference.

### FIELD

Embodiments of the subject invention pertain to a method of playing a game and an electronic gaming machine incorporating the method. More particularly, embodiments disclosed herein pertain to such methods and machines for providing multiplier-based rewards in connection with a matching game where the outcome of a random configuration of game elements produces a predetermined winning outcome.

### BACKGROUND

Electronic gaming machines for playing matching games are generally well known and have been popular for a number of years. As is customary with such machines, a display is usually provided having multiple game positions where particular gaming symbols or elements are displayed. Typically, during play of such games, the gaming symbols or elements are variable and will eventually stop with a set of symbols or elements in a particular fixed position relative one another.

A video slot machine is an example of such gaming machines. Generally, where a preselected collection of game elements span across a designated horizontal game line, a winning outcome is obtained. Typically, the game elements featured in such games are discrete images or symbols which, although considered for matching purposes, generally do not have any collective visually representative effect across the one or more game lines. In addition, the game elements used in connection with such games usually have only a single property that determines the outcome of the game.

Thus, such games and gaming machines have certain limitations with regard to the visual presentation of possible outcomes. It is generally known that due to such limitations, player interest in such games can drop over a period of time which can result in certain individual players deciding to cease playing the game and/or decline to play such machines again in the future. Hence there are on-going needs to try to bring play variations to the audience of players in order to sustain their interest and desire to continue playing.

In settings where players are allowed to place wagers on the outcome of such matching games, there are further on-going needs for electronic gaming machines and methods that can multiply rewards to a player where the game produces an outcome associated with a predetermined winning configuration of game elements that occurs infrequently relative to the total number of outcomes. There is a further need for machines and methods that can provide such multiplied rewards in proportion to the odds of obtaining particular winning configurations.

### BRIEF DESCRIPTION OF THE DRAWINGS

FIG. 1 illustrates a first sample configuration of a game as displayed on a gaming machine in accordance herewith.

FIG. 2 illustrates a second sample configuration of a game with a sample winning outcome as displayed on a gaming machine in accordance herewith.

FIG. 3 illustrates a third sample configuration of a game with a second sample winning outcome and winning outcome indicator as displayed on a gaming machine in accordance herewith.

FIG. 4 illustrates a fourth sample configuration of a game with a third sample winning outcome as displayed on a gaming machine in accordance herewith.

FIG. 5 illustrates a fifth sample configuration of a game with a forth sample winning outcome as displayed on a gaming machine in accordance herewith.

FIG. 6 illustrates a sixth sample configuration of a game as displayed on a gaming machine in accordance herewith.

FIG. 7 is a block diagram of a gaming machine in accordance herewith.

FIG. 8 is a flowchart illustrating a method in accordance with embodiments of the subject invention.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated. For example, although embodiments described herein are set forth in connection with a game presented on a matrix with twelve rectangular game elements arranged in three rows and four columns, the subject embodiments are not limited to such and can instead be presented in alternate forms with different arrangements, sizes, shapes, orientations or numbers of game elements, without limitation.

Embodiments disclosed herein provide a more entertaining and dynamic gaming experience by providing an electronic gaming machine and method for playing a matching game with game elements having multiple properties that can be determinative of the game's outcome. Such game elements additionally provide a new and more visually appealing presentation of winning outcomes which tend to heighten player enjoyment and entertainment. Embodiments additionally provide multiplier-based rewards where particular predetermined winning outcomes are obtained. It will be recognized that such features will generally induce a player to continue playing the game and/or select the game over other competing games in the future. It will be further understood that other benefits and advantages of the invention will become apparent in the following disclosure.

According to embodiments presented herein, the game can feature a plurality of game elements presented on an array or matrix, with each game element having one or more properties or characteristics. For example, as described in connection with the illustrated embodiments, the game elements can have a first property representative of a graphic character and a second property being a color behind the character. The game can be played by randomly varying the game elements relative a plurality of game positions on the matrix until a fixed configuration of game elements is presented. This configuration can be representative of the outcome of a “play.”

According to the rules of the game, the configuration of game elements can be a predetermined winning or non-winning outcome. For instance, a predetermined winning outcome can be produced where a play results in a configuration having adjacent game elements with the same second property (background color). Where such a winning outcome has been produced, the adjacent game elements with the same background color can form a winning indicator symbol which can display the first property (the graphic characters) of the winning game elements in an interactive manner. In addition, where a player has placed a wager on the outcome of the game and a winning outcome has been produced, embodiments disclosed herein can further provide for multiplying the wager by a predetermined factor to enhance the reward to the player.

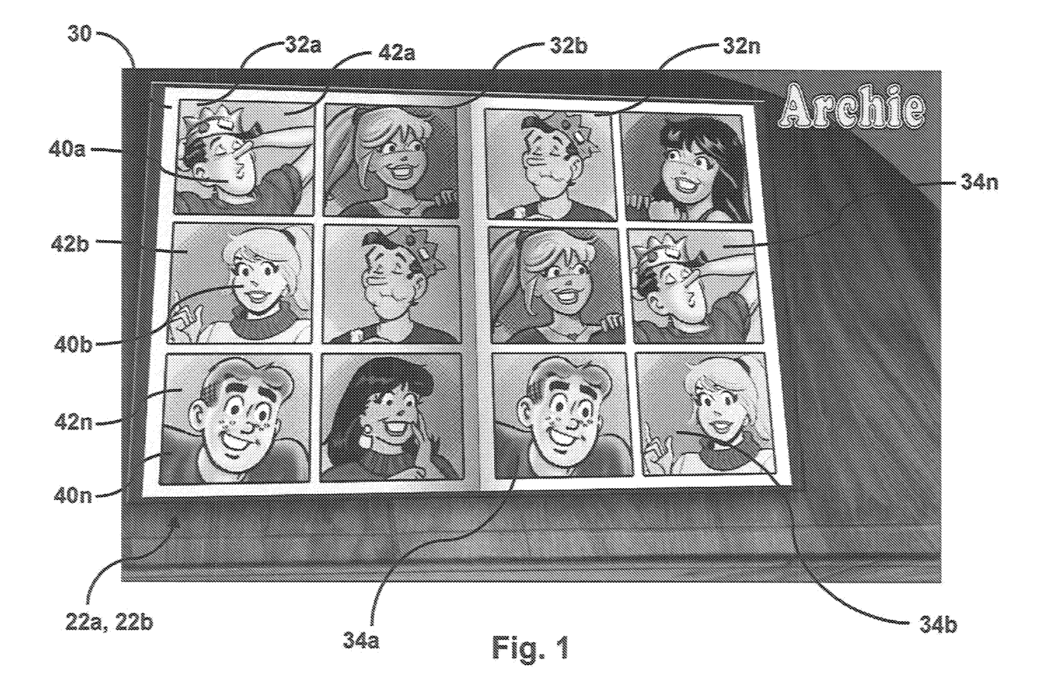

With reference now to the figures, a gaming machine 10 is illustrated for playing a matching game in which a player can place a wager and be rewarded if the outcome of a random assortment of game elements produces a configuration that is within the parameters of the game and recognized as a predetermined winning outcome. FIGS. 1 through 6 illustrate exemplary configurations of the game as played on the gaming machine 10 according to embodiments of the subject invention.

As illustrated in the figures, the gaming machine 10 can feature one or more display devices 22a, 22b that present an array or matrix 30 having a plurality of game positions 32a, 32b . . . 32n for presenting a configuration of game elements 34a, 34b . . . 34n. According to the embodiments illustrated in FIGS. 1 through 6, the matrix 30 can have a one or more vertical columns and one or more horizontal rows. It will be understood, however, that the matrix 30 can have alternate arrangements having at least two gaming positions 32a, 32b . . . 32n for presenting a subset of at least two selected game elements 34a, 34b . . . 34n that are randomly chosen from a set of at least three game elements 34a, 34b . . . 34n.

The game elements 34a, 34b . . . 34n presented on the array 30 can each have at least one property that can be determinative of the outcome of the game. For example, in the embodiment illustrated in FIGS. 1-6, each game element 34a, 34b . . . 34n has both a first property 40a, 40b . . . 40n, that is representative of a figure or character, and a second property 42a, 42b . . . 42n that is a background color visible behind the character. It will be understood, however, that the game elements 34a, 34b . . . 34n can have alternate or additional properties without departing from the novel scope of the subject invention. For example, such properties can include figures, animals, letters, symbols, colors, patterns, structures or any other recognizable image that can be visibly presented.

During play of the game, game elements 34a, 34b . . . 34n are randomly varied at each game position 32a, 32b . . . 32n to provide a configuration of game elements 34a, 34b . . . 34n across the matrix 30. The game elements 34a, 34b . . . 34n can be selected at random from a universe or superset of possible game elements with multiple selections of identical game elements 34a, 34b . . . 34n being allowed. According to embodiments set forth herein, specific configurations of game elements 34a, 34b . . . 34n can be characterized as predetermined winning and non-winning outcomes of the game. For instance, according to preferred embodiments, a predetermined winning outcome can be produced where a play results in a configuration where adjacent game positions 32a, 32b . . . 32n have game elements 34a, 34b . . . 34n with identical second properties 42a, 42b . . . 42n (background color). According to such embodiments, such a winning outcome can occur from the selection of game elements 34a, 34b . . . 34n with identical second properties 42a, 42b . . . 42n (background color) in vertically or horizontally adjacent game positions 32a, 32b . . . 32n. In addition, persons of ordinary skill in the art will understand that a configuration wherein diagonally adjacent game positions have identical background color can also be characterized as a predetermined winning outcome.

Although not required, it will be further understood that the relationship of the characters 40a, 40b . . . 40n presented on adjacent game elements 34a, 34b . . . 34n can also be determinative of the outcome of the game and/or an outcome meriting increased rewards. For example, where the characters 40a, 40b . . . 40n of the adjacent game elements 34a, 34b . . . 34n are in some predetermined relationship, such as being identical or otherwise having some other type of non-arbitrary relationship, additional rewards may be given to a player.

FIG. 1 illustrates a first sample configuration of randomly selected game elements 34a, 34b . . . 34n as presented on a matrix 30 as a result of a play of the game or an initial configuration displayed at startup prior to any game being played. In this sample configuration, none of the randomly selected game elements 34a, 34b . . . 34n in adjacent game positions 32a, 32b . . . 32n have an identical background color 42a, 42b . . . 42n. Thus, in this embodiment, the presented configuration is a predetermined non-winning outcome.

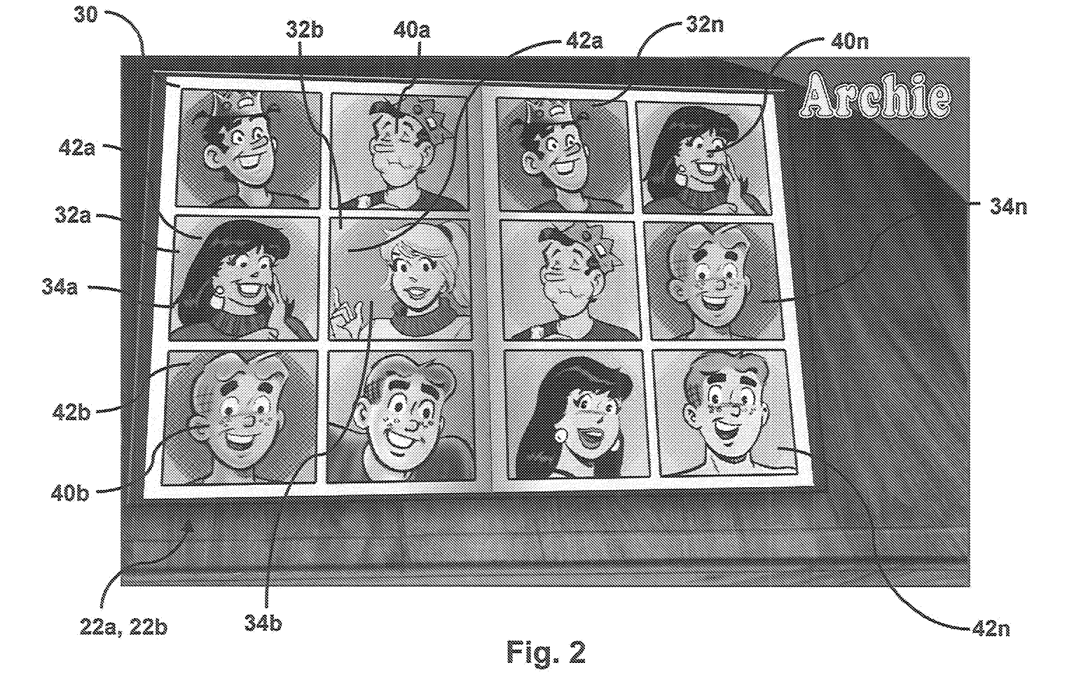

In FIG. 2, a second sample configuration of a game is illustrated. In this embodiment, the sample configuration is characterized as a winning outcome. Specifically, as can been seen, horizontally adjacent game positions 32a, 32b located in the second row from the top in the first and second columns from the left have game elements 34a, 34b with an identical background color 42a. Thus, in this embodiment, the presented configuration can be a predetermined winning outcome.

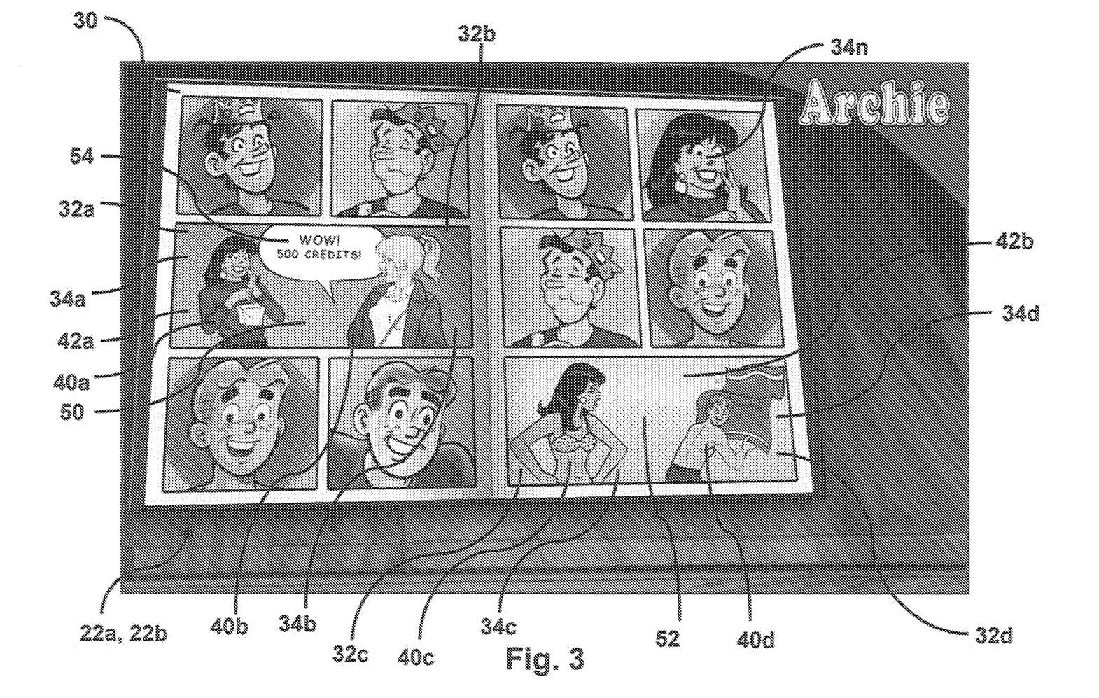

FIG. 3 illustrates another sample configuration of a game according to embodiments presented herein. In this sample configuration, the random selection of game elements 34a, 34b . . . 34n has resulted in a configuration having two winning outcomes. Specifically, horizontally adjacent game positions 32a, 32b located in the second row from the top in the first and second columns from the left have game elements 34a, 34b with an identical background color 42a. In addition, horizontally adjacent game positions 32c, 32d located in the bottom row in the third and fourth columns from the left have game elements 34c, 34d with an identical background color 42b.

According to the embodiment shown in FIG. 3, where the random selection of game elements 34a, 34b . . . 34n results in horizontally adjacent game positions 32a, 32b, 32c, 32d having game elements 34a, 34b, 34c, 34d with an identical second property 42a 42b (i.e. background color), a single contiguous winning indicator symbol 50, 52 can be formed on the matrix 30 at the adjacent game positions 32a, 32b, 32c, 32d. As shown in FIG. 3, the winning indicator symbol 50, 52 can display the characters 40a, 40b, 40c, 40d of the adjacent game elements 34a, 34b, 34c, 34d in an interactive manner. For instance, as shown in FIG. 3, the characters 40a, 40b, 40c, 40d presented in the winning indicator symbols 50, 52 are interacting with one another.

As show in FIG. 3, the interaction among the characters on the winning indicator symbol 50, 52 can further include an indicator graphic 54, such as for example a text bubble, identifying how much has been won on the game. It will be further understood that additional or alternative graphics, images or audible sounds can be used to provide the player with notification that the game has resulted in a winning outcome from matching adjacent game elements 34a, 34b . . . 34n according to the rules of the game. It will be understood that the presentation of such winning indicator symbols 50, 52 and such indicator graphics 54 or other notifications can visually appeal to a player and contribute to the player's enjoyment of the game.

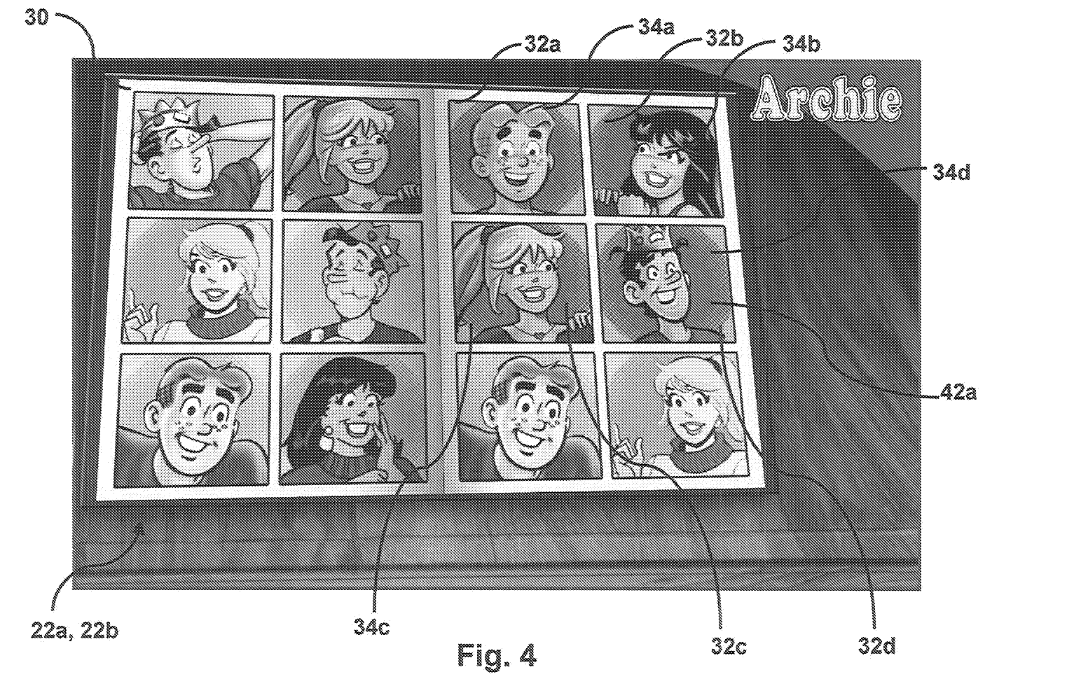

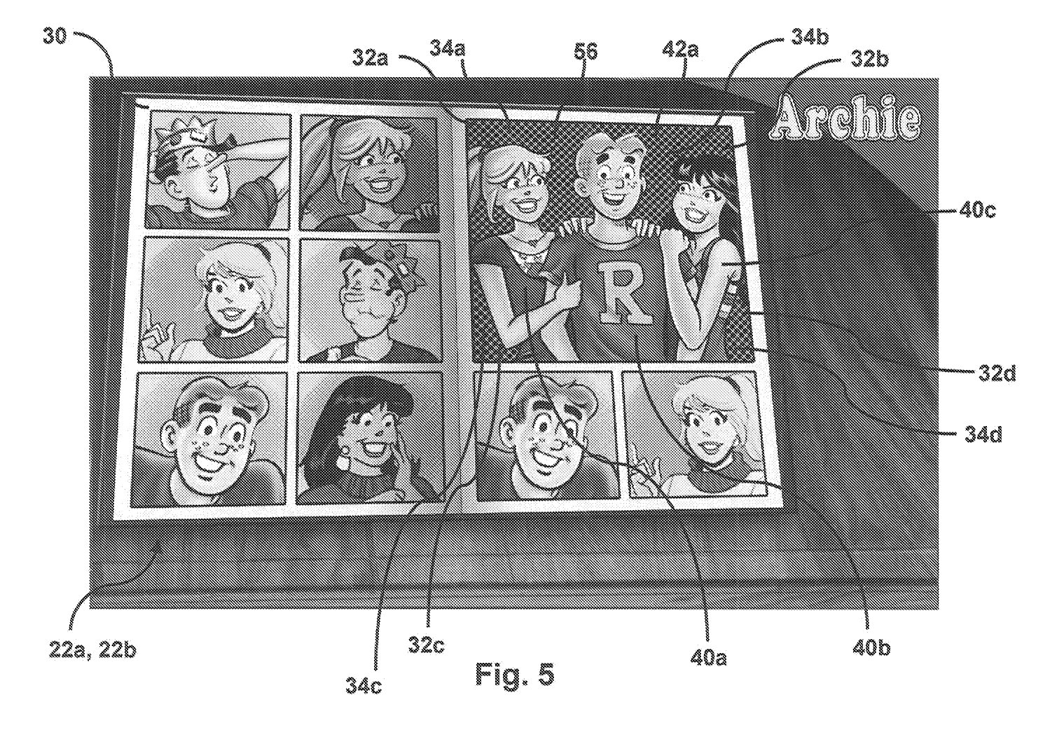

FIGS. 4 and 5 illustrate additional sample configurations of a game with winning outcomes presented in accordance with embodiments disclosed herein. As shown, a winning configuration can be formed by both horizontally and vertically adjacent game elements 34a, 34b, 34c, 34d. Specifically, the game elements 34a, 34b, 34c, 34d in the first and second rows from the top in the third and fourth columns from the left each have the same second property 42a (background color) and thus a winning outcome has been produced from four game positions 32a, 32b, 32c, 32d.

It will be understood that the random formation of a winning outcome from four adjacent game positions 32a, 32b, 32c, 32d as illustrated in FIGS. 4 and 5 will be less probable than producing a winning outcome from matching second properties 42a in two adjacent game positions 32a, 32b as shown for example in FIGS. 2-3. Thus, games producing winning outcomes from four adjacent game positions 32a, 32b, 32c, 32d can provide for higher payouts over winning outcomes produced from matching two adjacent game positions 32a, 32b. Similarly, winning outcomes formed by matching more than four game elements (not specifically shown) will likely be less probable than winning outcomes formed by four game elements 34a, 34b, 34c, 34d, and thus provide for further increased payouts to a player.

As illustrated in FIG. 5, a winning outcome formed by matching background color 42a of both horizontally and vertically adjacent game elements 34a, 34b, 34c, 34d can produce a single contiguous winning indicator symbol 56 on the matrix 30 at the matching game positions 32a, 32b, 32c, 32d. Specifically, where the random selection of game elements 34a, 34b . . . 34n results in horizontally and vertically adjacent game positions 32 having game elements 34a, 34b . . . 34n with an identical second property 42a (i.e. background color), a single contiguous winning indicator symbol 56 can be formed on the matrix 30 at the four adjacent game positions 32a, 32b, 32c, 32d having identical second properties 42a.

As shown in FIG. 5, the winning indicator symbol 56 can display the characters 40a, 40b, 40c of the adjacent game elements 34a, 34b, 34c, 34d in an interactive manner. For instance, as shown in FIG. 5, the characters 40a, 40b, 40c presented in the winning indicator symbols 56 are interacting with one another. Such a winning indicator symbol can further include an indicator graphic (not shown) of the type as previously described (element 54) in connection with FIG. 3.

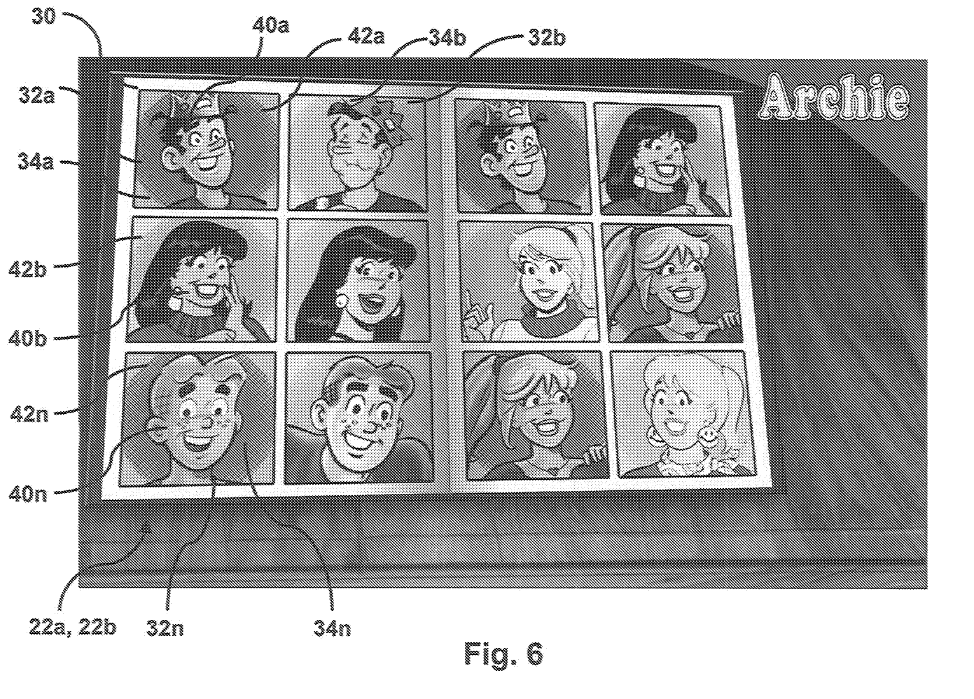

FIG. 6 illustrates another sample configuration of randomly selected game elements 34a, 34b . . . 34n as presented on a matrix 30 in accordance with embodiments presented herein. Although the configuration shown in FIG. 6 features several horizontally and vertically adjacent game positions 32a, 32b having game elements 34a, 34b with the same type of character 40a, 40b . . . 40n, none of the randomly selected game elements 34a, 34b . . . 34n in adjacent game positions 32a, 32b . . . 32n have an identical second property 42a, 42b . . . 42n (background color). Thus, the embodiment shown in FIG. 6 presents a configuration that can be associated with a predetermined non-winning outcome.

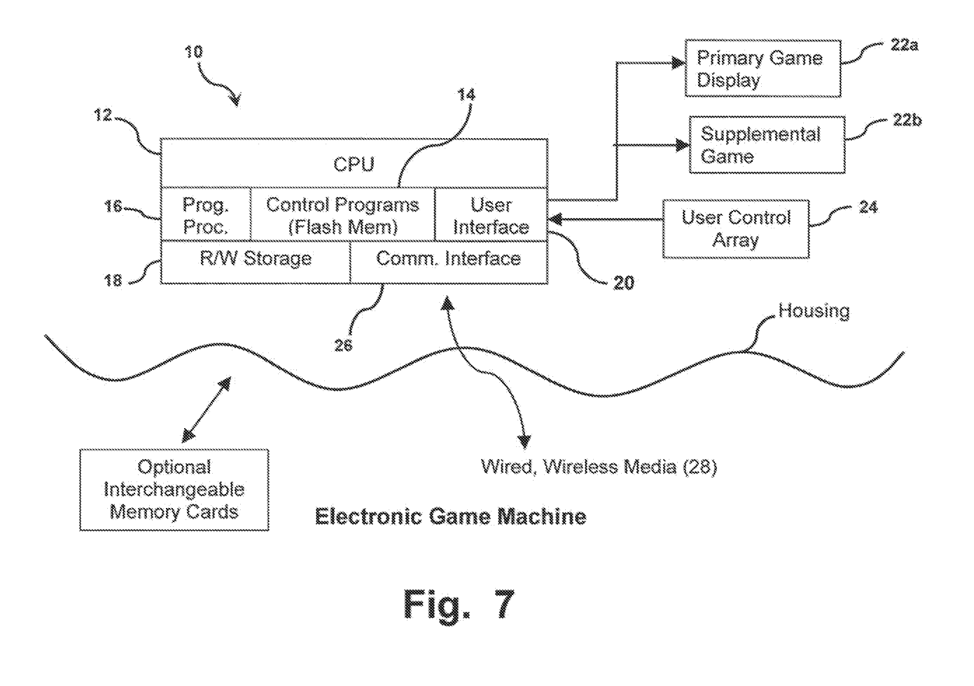

FIG. 7 illustrates components of an electronic gaming machine 10 according to embodiments of the subject invention. As shown in FIG. 7, the gaming machine 10 can feature a computer 12, at least one game display 22a 22b and a user control array 24. The computer 12 can have random access memory 12, a programmable processor 16, at least one storage unit 18 and user interface 20. In addition, the memory 12 can include a main memory containing dynamic information processed by the programmable processor 14 during operation, and/or a static memory which contains fixed information, such as an operating system, game programs, and configuration information necessary for the processor 16 to consistently process input from a player through the control array 24 to carry out the game.

Embodiments of the subject invention can further provide that the control array 24 can be a keyboard, a touch-screen, control buttons or pads and/or any other means for control or desired combination of controls able to accept input from a player and produce output to the game display 22 in response to a player's input. Additionally, the gaming machine 10 can incorporate one game display 22 or multiple game displays 22a, 22b which can be any type of device for visually presenting electronic images, such as for example an LCD, LED or CRT display device. It will be understood that game display 22a 22b, the computer 12 and control array 24 can be operatively connected via wired or wireless communication and can be located together in a single unit or housing or in separate individual units.

The gaming machine 10 can additionally have communication interface 26 for transmitting or receiving information from the computer 12 via wired or wireless communication to other or devices or media such as for example remote or external computers, gaming machines, internal or external networks, servers or displays. It will be understood that the communication interface can be used to incorporate the subject invention into a larger system of games which can be configured to communicate with each other, allow play against other players, or form a competition or a cooperative of competing teams rather than an exercise of individual chance or skill.

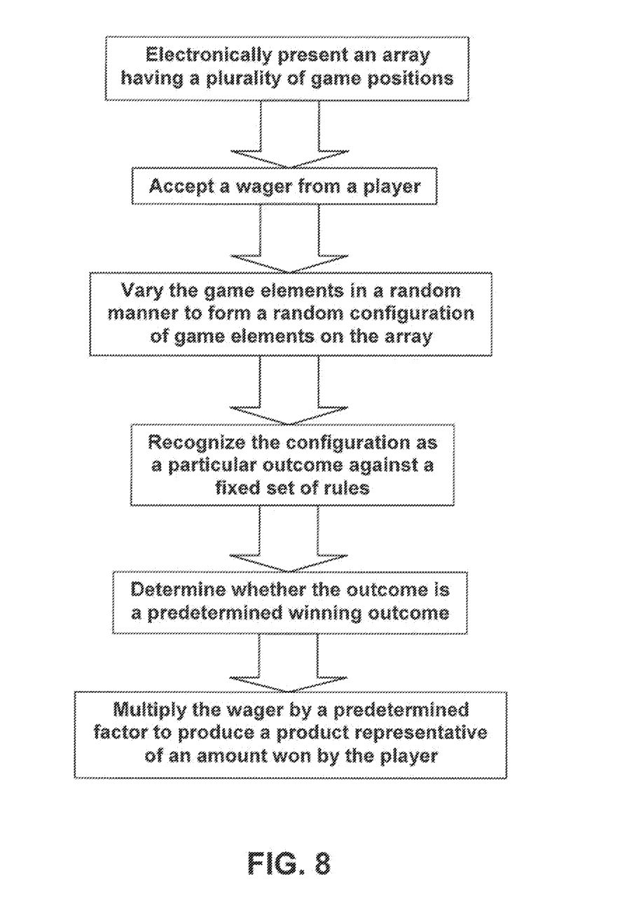

It will be understood that according to preferred embodiments, the game described herein can be played as a standard gambling or wagering game where a player places an initial wager, or pays an entry fee. According to such embodiments, the player can receive some multiple of the initial fee or wager back based upon the presentation of a winning outcome from the random selection of gaming elements 34. FIG. 8 illustrates a method carried out in accordance with such embodiments.

According to such embodiments, the game can start, from some first configuration of game elements 34a, 34b . . . 34n—typically the configuration produced by the particular individual outcome of the prior game. In playing the game, a display device 22a, 22b can electronically present an array of game elements 34a, 34b . . . 34n having an initial configuration. As previously set forth, each game position 32 can have a game element 34a, 34b . . . 34n selected from a superset of possible elements 34a, 34b . . . 34n with at least one property for determining the outcome of the game. Upon receiving input from a player, the game can accept a wager from a player and initiate the game by varying the game elements 34a, 34b . . . 34n in a random manner. The variation of game elements 34a, 34b . . . 34n during play of the game can produce a random configuration of game elements 34a, 34b . . . 34n presented on the array 30.

The game can recognize the random configuration as a particular outcome against a fixed set of rules. While there are any number of potential means for evaluating the outcome of a game, the computer 12 can contain within its static memory 14 either an algorithm for examining a particular outcome against a fixed set of rules to determine whether it is a winning outcome, or a list of all possible winning outcomes against which the particular outcome of a game can be compared. The computer 12 can additionally determine the outcome of a particular game using the rules stored in the static memory 14, and further recognize the outcome as a particular individual outcome.

Where a wining outcome has been produced and recognized, the game can further provide for multiplying the player's wager by a predetermined factor to produce an increased reward. It will be understood that the predetermined factor or multiplier may be any number greater than zero, including numbers smaller than one, but it is preferred, though not required, that multipliers equal to or greater than one be used. It is further preferred, but not required, that the multiplier applied upon achieving a particular winning configuration be proportional to the odds of getting the particular winning configuration the player achieves.

It is also preferred, but not required, that the total universe of possible configurations and the multipliers assigned to the subset of all possible winning configurations be configured such that over time, the player will tend to pay more in wagers than they receive in multiplied returned wagers. If this is not done, and the game is played for money, the player will over a long enough time interval accrue such large amounts of returned wagers that the operator of the machine 10 cannot make a profit from operating it. If the game is not played for money, this preference diminishes greatly in importance. Though it is neither preferred nor required, if the game is practiced in a regulated jurisdiction, the operator will be required by the regulatory authority of that jurisdiction to configure the total universe of possible configurations and the multipliers assigned to the subset of all possible winning configurations to reflect the requirements, if any, of that jurisdiction regarding percentage of wagers retained, absolute size of wagers and returned wagers permitted, volatility, or any other regulated aspect of such a game.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

What is claimed is:

1. A gaming machine for playing a game, the machine comprising:
a computer having a random access memory, a processor and storage unit, the storage unit storing a program comprising a sequence of electronic instructions executed by the processor;
a control array coupled to computer via a user interface, the control array receiving input from a player;
a game display operably connected to the computer, the display presenting an array having a plurality of game positions with a game element selected from a superset of possible elements at each game position, each game element having at least one property for determining an outcome of the game; and
during play of the game, the game elements being randomly variable at each game position to form a configuration of game elements on the array, the configuration being a predetermined winning or non-winning outcome of the game, the electronic instructions containing a multiplier that scales a wager placed by a player where the game produces a winning outcome.

2. The gaming machine of claim 1 wherein each game element has a first property being a stylized figure representative of a person or animal.

3. The gaming machine of claim 2 wherein each game element has a second property is a background color appearing behind the stylized figure.

4. The gaming machine of claim 3 wherein a configuration having adjacent game elements with identical second properties is a predetermined winning outcome.

5. The gaming machine of claim 4 wherein a predetermined winning outcome formed by a configuration of adjacent game elements with identical second properties form a single contiguous symbol that incorporates the first properties of the adjacent game elements and presents the first properties of the adjacent game elements in an interactive manner.

6. The gaming machine of claim 5 wherein the single contiguous symbol visually presents an indicator graphic identifying an amount won by the player.

7. The gaming machine of claim 1 where the control array comprises a keyboard, mechanical lever, control pad, button or touch-screen.

8. The gaming machine of claim 1 where the game display is a LCD, LED or CRT display device.

9. The gaming machine of claim 1 where the multiplier is a number equal to or greater than 1.

10. The gaming machine of claim 1 where the multiplier assigned to a predetermined winning outcome is inversely proportional to the probability that the outcome of the game will be the predetermined winning outcome, where the outcome of the game is randomly determined from a total universe of possible game outcomes.

11. The gaming machine of claim 4 wherein a configuration having a plurality of horizontally adjacent game elements with identical second properties is a predetermined winning outcome.

12. The gaming machine of claim 4 wherein a configuration having a plurality of vertically adjacent game elements with identical second properties is a predetermined winning outcome.

13. The gaming machine of claim 4 wherein a configuration having a plurality of horizontally and vertically adjacent game elements with identical second properties is a predetermined winning outcome.

14. The gaming machine of claim 13 wherein a predetermined winning outcome formed by a configuration of horizontally and vertically adjacent game elements with identical second properties form a single contiguous symbol that incorporates the first properties of the adjacent game elements and presents the first properties of the adjacent game elements in an interactive manner.

15. The gaming machine of claim 14 wherein the single contiguous symbol visually presents an indicator graphic identifying an amount won by the player.

16. A method for playing a game comprising:
electronically presenting on a display device an array having a plurality of game positions, each game position having a game element having at least one property for determining an outcome of the game, the game elements selected from a superset of possible elements;
accepting a wager from a player;
varying the game elements in a random manner to form a random configuration of game elements on the array;
recognizing the configuration as a particular outcome against a fixed set of rules;
determining whether the outcome is a predetermined winning outcome; and
where a wining outcome has been produced, multiplying the wager by a predetermined factor to produce a product representative of an amount won by the player and visually presenting the amount won on the array.

17. The method of claim 16 further comprising forming a single contiguous symbol from adjacent game elements having identical second properties, the contiguous symbol incorporating first properties of the adjacent game elements and presenting the first properties of the adjacent game elements in an interactive manner.

18. The method of claim 17 further comprising visually presenting an indicator graphic identifying an amount won by the player in the contiguous symbol.
